(19) United States
(12) Patent Application Publication
(10) Pub. No.: US 2025/0130708 A1
(43) Pub. Date: Apr. 24, 2025

(54) Secure Drag and Drop Between Applications

(71) Applicant: Omnissa, LLC, Mountain View, CA (US)

(72) Inventors: AJITH KUMAR VELUTHERI, Bangalore (IN); MADHAVAN KARA BHATTATHIRI, Bangalore (IN)

(21) Appl. No.: 18/607,343

(22) Filed: Mar. 15, 2024

(30) Foreign Application Priority Data
Oct. 19, 2023 (IN) 202341071439

(51) Int. Cl. G06F 3/0486; H04L 9/30

(52) U.S. Cl. CPC G06F 3/0486; H04L 9/30

(57) ABSTRACT

Described herein are systems and methods for securely sharing content between applications. In an example, trusted application can include a plug-in for a secure container that securely stores content. When a user drags content from an application to the plug-in, the secure container stores the content in a secure location that is inaccessible to other applications or services. A user can view and share content stored in the secure container at other trusted applications via the plug-in. In another example, a user can drag and drop content directly from a first application to a second application. The second application can provide the first application with a public encryption key that the first application can use to encrypt the content. After the content is dropped at the second application, the first application can send the content to the second application and the second application can decrypt the content.

### CROSS-REFERENCES

This application claims the benefit of Indian patent application Ser. No. 20/234,1071439, entitled “SECURE DRAG AND DROP BETWEEN APPLICATIONS,” filed on Oct. 19, 2023, of which is hereby incorporated by reference in its entirety.

### BACKGROUND

Drag and drop is a user interface (“UI”) technique that allows users to interact with digital content by selecting an object or element and moving it to a different location using a pointing device, such as a mouse or touchpad. It involves two primary actions: dragging and dropping. Drag and drop functionality is widely used in various software applications, operating systems, and web interfaces. It provides a convenient and intuitive way for users to manipulate objects, rearrange elements, organize files, and perform actions such as moving, copying, or linking content. Drag and drop interactions are commonly utilized in file managers, email clients, graphic design software, web page builders, and many other applications that involve manipulating digital objects within a visual interface.

Sharing data between applications using drag and drop on a mobile device can be challenging, at least in part due to the limited sized screen, operating space, and limitations of operating system (“OS”) UI capabilities. These limitations create difficulties with other data sharing techniques as well, such as parallel data sharing where data is shared among multiple applications in one action. There are also security concerns with drag and drop in an enterprise context. For example, with drag and drop operations, the source application typically gives the target application permission to access the source application's file system or common storage to access the dragged content. There is no way to restrict the target application's access to only the content being dragged. This poses a serious security risk for applications that contain sensitive data. As a result, enterprises are forced to disable data sharing features like drag and drop and parallel data sharing on many applications.

As a result, a need exists for a secure way to share data between applications.

### SUMMARY

Examples described herein include systems and methods for securely sharing data between applications on a user device. As used herein, the term “source application” is used to describe an application that shared content originates from, and the term “target application” is used to describe an application that receives the shared content. As an example, where a user executes a drag and drop operation to drag content from a first application to a second application, the first application is the source application, and the second application is the target application.

Some examples described herein relate to sharing content between applications through parallel data sharing. In such an example, a secure container can be used to secure the content being shared without granting any target applications access to the source application's file system. The secure container can be software that contains all the code and dependencies, including binaries, libraries, and configuration files, needed for securely storing dragged content in a protected environment. A user can drag content from a trusted application to the secure container to make the content available at other trusted applications. For example, trusted applications, or applications given proper permissions by an enterprise, can include a plug-in of the secure container. If a user drags content to the plug-in, the secure container can store the content in a secure location that is only accessible to other trusted applications. The user can then access the content at other trusted applications using the plug-in. For example, selecting the plug-in in another application can cause the plug-in to display any content previously dragged to the plug-in.

Some examples described herein relate to sharing content directly between trusted applications using a drag and drop operation. In such an example, a source application can share content with a trusted application without granting the trusted application access to the source application's file system. For example, when a user drags content from a source application to a trusted application, the trusted application can determine that it is the intended recipient in the drag and drop operation. In response, the trusted application can send a public encryption key of an encryption key pair to the source application. The source application can encrypt a copy of the content using the target application's key and send the encrypted content to the trusted application. The trusted application can then decrypt the content using a private encryption key associated with the public key. This protects the content from other applications or services running on the user device, and at the same time does not expose the source application's file system.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for securely sharing content between applications through parallel data sharing.

FIG. 2 is a sequence diagram of an example method for securely sharing content between applications through parallel data sharing.

FIG. 3 is another flowchart of an example method for performing a secure drag and drop operation.

FIG. 4 is another sequence diagram of an example method for performing a secure drag and drop operation.

FIG. 5 is an illustration of an example system for performing various methods disclosed herein.

### DETAILED DESCRIPTION

Reference will now be made in detail to the present examples, including examples illustrated in the accompanying drawings. Wherever possible, the same reference numbers will be used throughout the drawings to refer to the same or like parts.

Described herein are systems and methods for securely sharing content between applications. In one example, a trusted application can include a plug-in for a secure container that securely stores content. When a user drags content from an application to the plug-in, the secure container stores the content in a secure location that is inaccessible to other applications or services. A user can view and share content stored in the secure container at other trusted applications via the plug-in.

In another example, a user can drag and drop content directly from a first application to a second application. The second application can provide the first application with a public encryption key that the first application can use to encrypt the content. After the content is dropped at the second application, the first application can send the content to the second application and the second application can decrypt the content.

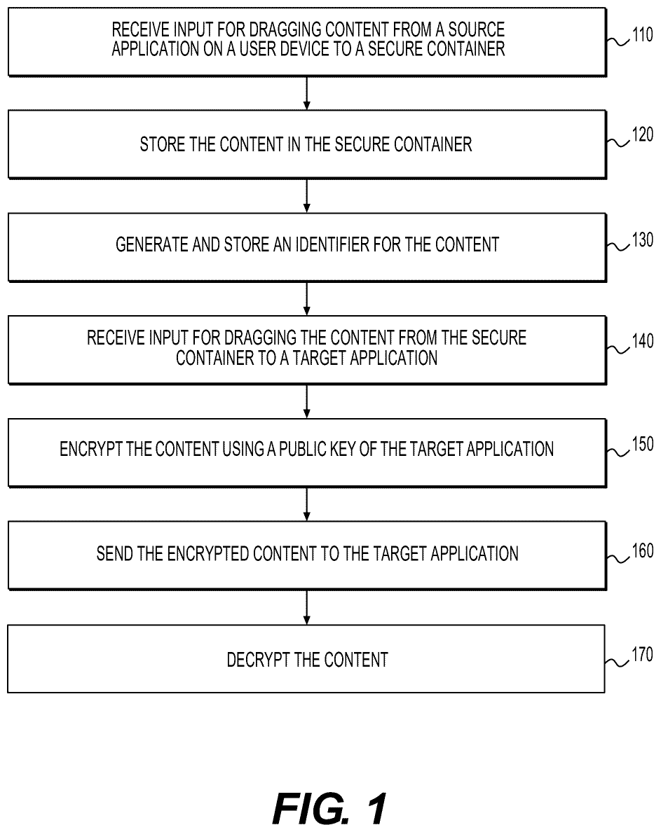

FIG. 1 is a flowchart of an example method for securely sharing data through parallel data sharing. At stage 110, a user device can receive an input for dragging content from a source application on a user device to a secure container. The user device can be one or more processor-based devices, such as a personal computer, tablet, or cell phone. The input can be any kind of dragging input for dragging content from one location to another within a UI of the user device, such as with a drag and drop operation. For example, a user can select content, such as with tap or click, and maintain the selection while moving the content across a display of the user device. The application and secure container can be displayed simultaneously on the user device's display during the drag and drop input from the user. The user can select content displayed in the application and drag the content to the secure container. Content can be any element visually depicted on a display. For example, content can be an image, text, or data file, such as an audio or video file.

The secure container can be software that contains all the code and dependencies, including binaries, libraries, and configuration files, needed for securely storing dragged content in a protected environment. For example, only trusted applications can be given access to the secure container. The secure container can communicate with trusted applications on a secure peer-to-peer (“P2P”) channel within the user device. Trusted applications can be given configuration settings and credentials required for communicating on the secure P2P channel. The secure container can be configured to only communicate on the secure P2P channel, so only trusted applications can communicate with the secure container.

In one example, the secure container can be a web application that is hosted by a web server, and a user can access the application through a web browser. The application can be hosted by one or more servers or a group of servers, including multiple servers implemented virtually across multiple computing platforms. A user can drag an option to the secure container by loading the secure container UI in a web browser and dragging content from the source application to the web application. Alternatively, the secure container application as a whole, its UI, or other components of the application may be installed directly on a user's device.

In an example, the trusted applications and share library can be managed on the user device by a system that allow enterprises to manage work-related applications and data on enrolled user devices, such as a Unified Endpoint Management (“UEM”) system. A management server of a UEM system can manage enrolled user devices by sending management instructions to a management application installed on the user devices. The management server can be a single server or a group of servers, including multiple servers implemented virtually across multiple computing platforms. The management application can be a stand-alone application, part of an enterprise application, or part of an operating system of the user device.

The management application can be responsible for ensuring that the user device is up to date with compliance and security settings prior to accessing enterprise data and resources. The management application can communicate with the management server, allowing UEM management of the user device based on compliance and security settings at the management server. The management application can enforce compliance at the user device, such as by locking the user device, notifying an admin, or wiping enterprise data when compliance standards are not met. Example compliance standards can include ensuring a device is not jailbroken, that particular encryption standards are used in enterprise data transmission, that the device does not have certain blacklisted applications installed or running, and that the device is located within a geofenced area when accessing certain enterprise resources. In one example, the user device can access enterprise or UEM resources through the management server.

The management server can also manage certain applications installed on the user device. For example, the trusted applications can include applications that are managed by the management server. A managed application can allow an enterprise to control access and functionality of the application, including data files, application files, UEM policy files, and user files. Additionally, a managed application can persist locally on the user device or can be accessed from within the management application, depending on the example. Even when an application is accessed remotely, portions of that application or data utilized by the application can exist locally on the user device.

In an example, the UEM system can manage application permissions using application profiles. Application profiles can designate what operations an application can and cannot do on a user device, including whether drag and drop operations can be performed. For example, a profile can designate whether a user can drag content from an application to a secure container or other application, or whether content can be dragged to the application from another application or a secure container.

At stage 120, the user device can store the content in the secure container. The secure container can protect data content from unauthorized access both inside and outside the user device. In one example, the user device can store the content in the secure container by encrypting the data content using a cryptographic key that is stored in a secure hardware component of the user device, such as Trusted Execution Environment (“TEE”) or Secure Element (“SE”). In some examples, the user device can use security systems provided by the user device's operating system (“OS”). For example, ANDROID KEYCHAIN provides a secure storage system for cryptographic keys, certificates, and sensitive data on ANDROID devices. ANDROID KEYCHAIN can store private data in containers called “keystores” that are secured by the ANDROID OS and are inaccessible to other applications. IOS KEYCHAIN provides similar services on APPLE devices. The secure container can make an Application Programming Interface (“API”) call to the corresponding KEYCHAIN service to securely store the content.

At stage 130, the user device can generate and store an identifier for the content (hereinafter referred to as an “content ID”). The content ID can be, or include, a content Unified Resource Identifier (“URI”). A content URI is a type of URI that is used to identify and access specific data within an application or across different applications. Content URIs consist of two main components: the authority and the path. The authority identifies a content provider that manages the data, while the path specifies the specific data or resource within that content provider. In one example, the content ID can be encrypted using a user authenticated secure key whose access is restricted until the user authenticates using an approved, secure method, such as a device personal identifier number (“PIN”), biometric authentication, or a username and password combination. The key for decrypting the content ID remains inaccessible unless the user properly authenticates on the user device. In one example, the secure container can require a user to authenticate when accessing any content stored therein.

At stage 140, the user device can receive input for performing a second drag and drop operation for dragging the content from the secure container to a target application on the user device. In an example, trusted applications can be configured with a plug-in associated with the secure container. To add content to the secure container, a user can drag content and drop the content in the plug-in. The secure container can store the content's ID in a cache on the user device that the plug-ins on other trusted applications can access. When the user performs a certain selection input on the plug-in in another app, such as a tap or long press, the plug-in can display all items dropped from other trusted applications. The user can drag content out of the plug-in and into the application to copy the content to that application's file system. The plug-in allows users to share data between apps using drag and drop operations without requiring that both applications are visible during the drag and drop operation.

At stage 150, the secure container can encrypt the content using a public key of the target application. In one example, the secure container can request the target application's public key. In another example where the target application includes a plug-in of the secure container, the secure container can obtain the target application's public key when the plug-in is installed. The secure container can then use that public key to encrypt all content shared with the target application. In another example, the content can be encrypted by, or by using an encryption key provided by, the user device's OS. For example, the content can be encrypted using ANDROID KEYCHAIN and passed on to the trusted application.

At stage 160, the secure container can send the encrypted content to the target application. For example, the secure container can make an API call to the trusted application that includes the encrypted content as the payload. In one example where the OS securely stores the content, the secure container can instruct the OS to provide the content to the trusted application. At stage 170, the target application can decrypt the content. The target application can do this, for example, using its corresponding private key. The target application can then store the content in its file system.

In some examples, customized drag and drop permissions can be assigned to applications. For example, applications can be given permission to operate as a source application or target application (i.e., users can drag content both from and to the application), restricted to operating as a source application only (i.e., users can only drag content from the application), restricted to operating as a target application only (i.e., users can only drag content to the application), or prohibited from drag and drop operations altogether. In an example, permissions can be assigned at an admin console. An admin console can be an interface that allows an administrator to manage application drag and drop permissions for an organization. When drag and drop permissions are removed for an application, the user device can erase any content previously added to the secure container from the application. The user device can also erase any encryption keys specific to the application that are used for drag and drop operations.

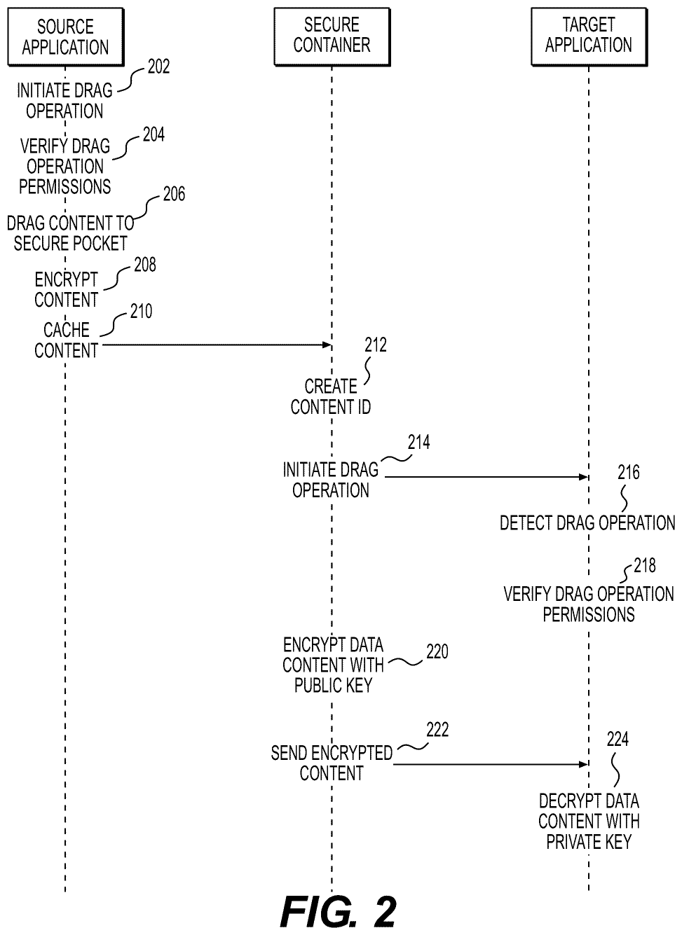

FIG. 2 is a sequence diagram of an example method for performing a secure drag and drop operation. At stage 202, a user can initiate a drag operation at a source application. For example, a user can select content and maintain the selection while moving the content across a display of the user device. The selection can be any kind of extended selection, such as a click or press and hold selection.

At stage 204, the source application can verify drag operation permissions. For example, when applications managed by a UEM system initiate, they can sync an application profile with a UEM management server. Application profiles can designate what operations an application can and cannot do on a user device, including whether drag and drop operations can be performed. Application profiles can be managed by admin users using an admin console. For example, an admin user can add, remove, or change drag and drop permissions from an admin console. Those changes can be applied to the corresponding application profiles. Every time an application initiates, the application can retrieve and up-to-date application profile. In some examples, changes to application profiles can be pushed to applications during runtime.

When a drag and drop operation is attempted, the source application can check the application profile to determine whether such an operation is permitted. If so, then the source application can allow operation to proceed. Otherwise, the application can block the operation.

At stage 206, the user can drag the content to a secure container, also referred to as a secure pocket. The secure container can be software that contains all the code and dependencies, including binaries, libraries, and configuration files, needed for securely storing dragged content in a protected environment. The secure container can protect data content from unauthorized access both inside and outside the user device. In one example, the secure container can be a separate application running on the user device that is visible on the user device's display in conjunction with the source application, and the user can drag the content from the source application to the secure container application. In an alternative example, the secure container can run as a plug- in or plug-in in the source application, and the user can drag the content to the plug-in.

At stage 208, the source application can encrypt the content. For example, rather than giving the secure container access to the entire file system of the source application, the source application can encrypt a copy of the content data file and provide the encrypted content to the secure container. To do this, the secure container can provide the source application with a public encryption key. The secure container can provide the key at any time before the source application provides the data content. For example, the secure container can provide the source application with the public key when the source application is installed or initiated, or when the drag and drop input is initiated or completed.

At stage 210, the secure container can cache the content. In one example, the secure container can cache the content in a secure location of its file system. The content can remain encrypted while cached. In another example, the secure container can cache the content using a secure storing mechanism provided by the OS, such as ANDROID KEYCHAIN or IOS KEYCHAIN. While stored in such a secure location, the content remains inaccessible to other applications and can only be retrieved and decrypted by the secure container.

At stage 212, the secure container can create content ID. The content ID can be any information that uniquely identifies the content and its location. In one example, the content ID can be a content URI that includes the authority and the path of the content. The content ID can be displayed visually in an interface of the secure container. For example, after dragging an object to the secure container in one application, a user can select the secure container in another application to view the content ID. The secure container can store the content IDs of all content dragged to the secure container. A user can select the secure container from any application on the user device with the appropriate permissions to view these content IDs. The user device can be configured to wipe the content IDs from the secure container after a predetermined event occurs, such as after a predetermined amount of time, when the user device restarts or shuts down, or when the user device is unenrolled.

At stage 214, the user can initiate a second drag operation for dragging the content from the secure container to a target application. For example, as described above, the content ID can be displayed in an interface of the secure container, such as an application UI or a plug-in UI within the target application. The user can select the content ID can drag the content ID into the target application.

At stage 216, the target application can detect the drag operation. For example, the target application can be configured to monitor when a drag and drop input occurs. In one example, the secure container can determine when a user drags content from the secure container and notify the target application.

At stage 218, the target application can verify its drag operation permissions. For example, the target application can check the application profile described at stage 204 to determine whether the target application has permission to receive dragged content. If so, the target application can allow the user to drag the content to the target application. If not, the target application can block the operation. In one example, the target application can identify itself as the destination of the drag and drop operation when the content is dragged into an area of the user device's display that is displaying the target application's UI.

When the target application does have drag and drop permissions, at stage 220, the secure container can encrypt the content with a public key of the target application. For example, after the user drops the content in the target application, the target application can provide the secure container with a public key. Alternatively, the user device's OS, or the management application on the user device, can store public keys for managed applications installed on the user device. When the target application of the drag and drop operation is identified, the secure container can retrieve the corresponding public key from the OS or management application. The secure container can locate the content based on the selected content ID, and then encrypt content using the public key. At stage 222, the secure container can send the encrypted content to the target application.

At stage 224, the target application can decrypt the content using a private key that corresponds to the public key. For example, the private key and public key can be part of an encryption key pair in which only the private key can decrypt items encrypted with the public key. The target application can store the private key in a secure location that is only accessible to the target application. The target application can decrypt the content using this private key and store the content in its file system.

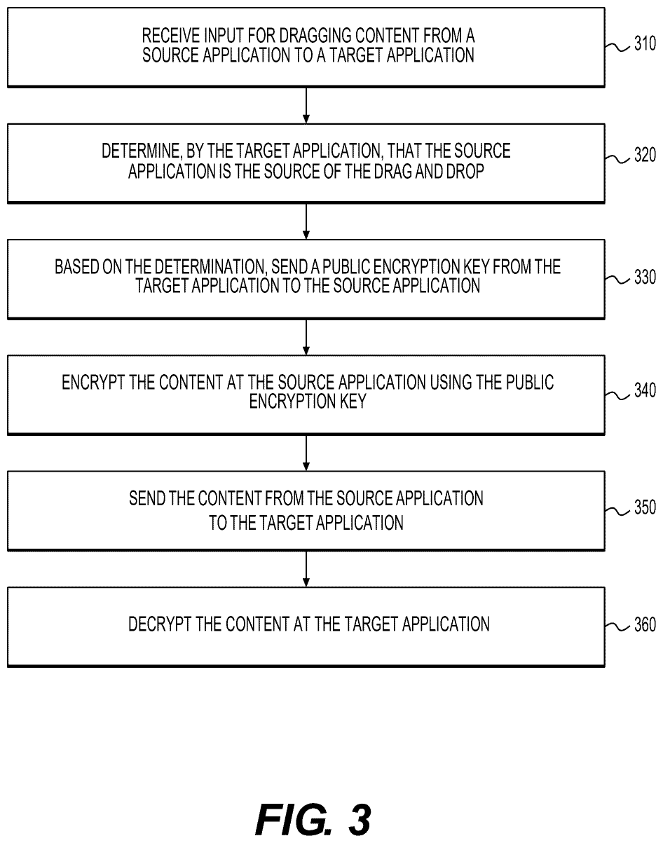

FIG. 3 is another flowchart of an example method for performing a secure drag and drop operation where content is dragged directly from a source application to a target application. This example method can be used when both the source and target applications can be visible on the user device's display, such as in a mobile platform multiwindow context. At stage 310, a user device can receive input for executing a drag and drop operation for content from a source application to a target application on the user device. For example, a user can select content in the source application, such as an image, text, or data file, and maintain the selection while dragging the content to the target application.

At stage 320, the target application can determine that the source application is a source of the drag and drop operation. In this stage, the target application can also identify itself as the destination of the drag and drop. In an example, the target application can make these determinations based on both applications being displayed simultaneously on the user device. For example, when a drag and drop operation is initiated and the target application is being displayed, the target application can be configured to detect the operation and determine the source application of the operation. When only two applications are being displayed, the target application can identify the source by identifying the other application being displayed. In an example, the target application can do this by querying the user device's OS. In another example, the OS, or alternatively the management application, can track drag and drop operations with managed applications. The target application can detect the drag and drop operation and query the OS (or management application) for the operation source.

At stage 330, based on the determination, the target application can send a public encryption key to the source application. The public encryption key can be part of an encryption key pair of the target application. In an example, managed applications can have an encryption key pair for encryption and decryption purposes. Each application can retain its encryption keys in a secure memory context. For securing content shared between managed applications during drag and drop operations, the target application can send its public key to the source application for encryption. In one example, the public key can be a user authenticated secure key. In other words, access to the encryption key pairs can be restricted until a user authenticates using any appropriate authentication method, such as by entering a device PIN, providing biometric credentials, or entering a username and password combination. In one example, the target application can send the public key to the private application using an API call.

In some examples, the source application and target application can verify drag and drop permissions before any encryption keys are exchanged. For example, after initiating, managed application can sync an application profile with a UEM management server. Application profiles can designate what operations an application can and cannot do on a user device, including whether drag and drop operations can be performed. When a user initiates a drag and drop operation from a source application, the source application can check its profile to determine whether content can be dragged from the source application. For example, an application profile can block an application from all drag and drop operations or just from being a source application. In other words, an application can be configured so that it can receive content from drag and drop operations, but it prohibited from dragging content out of the application to another application. This can be particularly useful for applications that manage sensitive data, such as financial data. Such an application can receive content from other applications, but any data inside the application is protected and cannot be dragged out. If the source application is not allowed to drag content to another application, the source application can block the operation. Otherwise, then the source application can allow the operation.

After the target application determines that it is the target of the operation, the target application can check its own permissions and determine whether content can be dragged to the target application. For example, the target application can be prohibited from all drag and drop operations or only from receiving content from such operations. If the operation is prohibited by the target application, then the target application can block the operation. In one example, the target application can block the operation by not sending the public key to the source application. The source application can terminate the operation if it doesn't receive a public key, thereby ensuring that the content is not transferred in an unprotected manner or to an unauthorized application.

At stage 340, the source application can encrypt the content using the public encryption key. This can occur, for example, when both the source application and target application have the appropriate permissions and the target application provides public key. Rather than giving the target application access to the entire file system of the source application, the source application can instead encrypt only the content being dragged using the public key of the target application. The target application, being the only entity with the corresponding private key, then becomes the only entity that can decrypt the content.

At stage 350, the source application can send the content to the target application. For example, the source application can make an API call that includes an encrypted data file that includes the dragged content. In an alternative example, the source application can send the encrypted content to the target application using an intermediary application or service. For example, the source application can send the application to a secure container, such as the secure container described previously herein. The secure container can temporarily cache the content before passing the content to the target application. In one example, the secure container can cache the content using a secure storing mechanism provided by the OS, such as ANDROID KEYCHAIN or IOS KEYCHAIN.

In an example, when a secure container is used, the secure container can detect the drag and drop operation originating at the source application. In response, the secure container can send its own public key to the source application for encrypting the content. This can happen before or after the drop portion of the operation. In one example, the secure container can verify the permissions of the source application and the target application. The source application can encrypt the content with the secure container's public key and send the encrypted content to the secure container. The secure container can securely cache the content in its encrypted form. After the target application is identified, the secure container can retrieve the target application's public key, decrypt the content using the secure container's private key, re-encrypt the content using the target application's public key, and then send the encrypted content to the target application.

At stage 360, the target application can decrypt the content using the private key associated with the public key. This private key can be secured maintained by the target application. After decrypting the content, the target application can cache the content for temporary use or save the content in its file system, depending on the example.

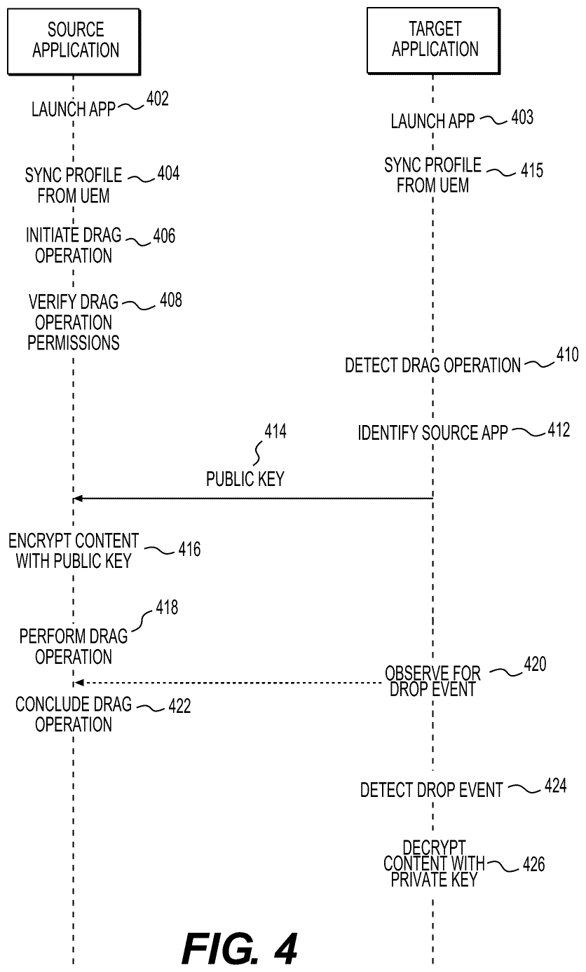

FIG. 4 is a sequence diagram of an example method for performing a secure drag and drop operation directly between two applications: a source application and a target application. At stage 402, the source application can launch. For example, the source application be configured to launch automatically when the user device's OS boots. Alternatively, a user can manually launch the application in the OS. At stage 403, the target application can launch. The source application and target application can launch in any order so long as both applications are running when a drag and drop operation is initiated by a user.

At stage 404, the source application can sync its application profile from a UEM management server. For example, the source application can be a managed application that allows a UEM system to control its functions and permissions. The application profile can designate what operations an application can and cannot do on a user device, including permissions related to drag and drop operations. For example, an application can be allowed to only send content, receive content, or both send and receive content through drag and drop operations. An application profile can also designate which applications an application can exchange content with using drag and drop operations. For example, an application can be limited to exchanging content through drag and drop operations only with other managed applications on the user device. In one example, the application profile can designate specific applications that an application can perform drag and drop operations with. This can include whether the application can send, receive, or both send and receive drag and drop content with any specific application.

At stage 415, the target application can sync its application profile from a UEM management server. The source and target applications can be configured to sync their application profiles each time they launch. Alternatively, or in addition, the source and target applications can sync their application profiles at specific intervals or times. For example, applications managed by the UEM can be configured to resync application profiles if they have not been updated after a predetermined amount of time, such as an hour or a day.

At stage 406, a user can initiate a drag and drop operation at the source application. In an example, the user can initiate the drop and drop input when both the source application and target application are visible on the user device's display. This can allow the applications to identify more easily which is the target application. For example, if two applications are displayed and a drag and drop operation is initiated at one of them, then the other application being displayed can more easily be identified as the target application. This can occur for example, in a mobile platform multiwindow context. The selection can be any kind of extended selection, such as a click or press and hold selection.

At stage 408, the source application can verify its drag and drop operation permissions. In an example, the source application can verify its drag and drop operation permissions in response to the user input. This can include reading the synced application profile and determining whether the source application has permission to function as a source application in a drag and drop operation. If so, the source application can allow the drag and drop operation to proceed. If not, the source application can block the operation, such as by preventing the selected content from being dragged across the user device's display. In an example, the source application can include an event handler that executes code in response to a drag input originating at the source application. This code can cause the source application to check the application profile and take the appropriate action.

At stage 410, the target application can detect the drag input. For example, the target application can include an event handler that monitors for drag and drop inputs. The event handler can include code that causes certain code to run when a drag and drop operation is initiated on the user device. For example, in response to a drag and drop input initiating at another application, the target application can verify its drag and drop operation permissions. This can include determining whether the target application is allowed to receive drag and drop content. The application profile can also designate whether the target application is allowed to receive drag and drop content from the source application specifically.

At stage 412, the target application can identify the source application. For example, the target application can check event logs of the OS that identify the source of the drag and drop operation. In one example, this can occur in conjunction with stage 410. For example, the event handler of the target application can subscribe to drag and drop events recorded by the OS. When the drag and drop operation is initiated, the OS can record the event, and the record can identify the source application. The event handler can read the event log to identify the source application. The target application can also verify its drag and drop permission in relation to the source application, such as by verifying that the source application is a managed or trusted application, or that the trusted application has permission to receive drag and drop content from the source application.

At stage 414, the target application can send a public encryption key to the source application. For example, managed applications on the user device can each generate a private/public encryption key pairing when installed on the user device or as part as the user device enrollment process. When the target of a drag and drop operation is identified, the target application can send its public key to the source application. The target application can send the public key using any available format, such as by sending the key as payload in an API call.

At stage 416, the source application can encrypt the content with the target application's public key. If the source application does not receive the public key, then the source application can terminate the drag and drop operation. For example, completion of the drag and drop operation can be dependent on the source application encrypting the dragged content with the target application's public encryption key. In one example, if the target application does not have permission to receive the dragged content from the source application, then the target application can simply not send its public encryption key, and the drag and drop operation therefore cannot be completed. In another example, the target application can send a message to the source application notifying the source application that the content cannot be received. On the other hand, if the source application receives the target application's public key, then the source application can know that the target application is allowed to receive the dragged content. In response, the source application can encrypt the content using the received public key.

At stage 418, the user can perform the drag portion of the drag and drop operation. For example, when the user performs a long selection on the content, the OS can display an image associated with the content while the user drags the content across the display. Some of the stages described previously can occur in conjunction with the user dragging the object. For example, after the drag and drop operation is initiated and while the user is dragging the content, the target and source applications can verify their permissions, the target application can send the public key, and the source application can encrypt the content. In some examples, these stages can occur after the content is dropped at the target application.

At stage 420, the target application can observe the drag operation for the drop event. For example, the OS can record logs of the drag and drop event, which can indicate whether and where a drop and drop operation begins and ends. The target applications event handler can wait for a drop at the target application to execute code for completing the operation. If, for example, the user begins the operation, but does not drop the content at the target application (e.g., the user manually cancels the operation or performs a different operation with similar input), then the source application does not send the encrypted content to the target application.

At stage 422, the user can complete the drag and drop operation by dropping the content at the target application. For example, the user can maintain the drag selection on the content and move the selection to the target application on UI of the OS, and then release the selection on the target application.

At stage 424, the target application can detect the drop event. For example, the OS can notify the target application. In another example, the OS can log an event of the drop, and the target application can be monitoring the OS logs for such an event in response to the drag input occurring previously.

At stage 426, the target application can decrypt the content with its private key. This private key can be secured maintained by the target application. After decrypting the content, the target application can cache the content for temporary use or save the content in its file system, depending on the example.

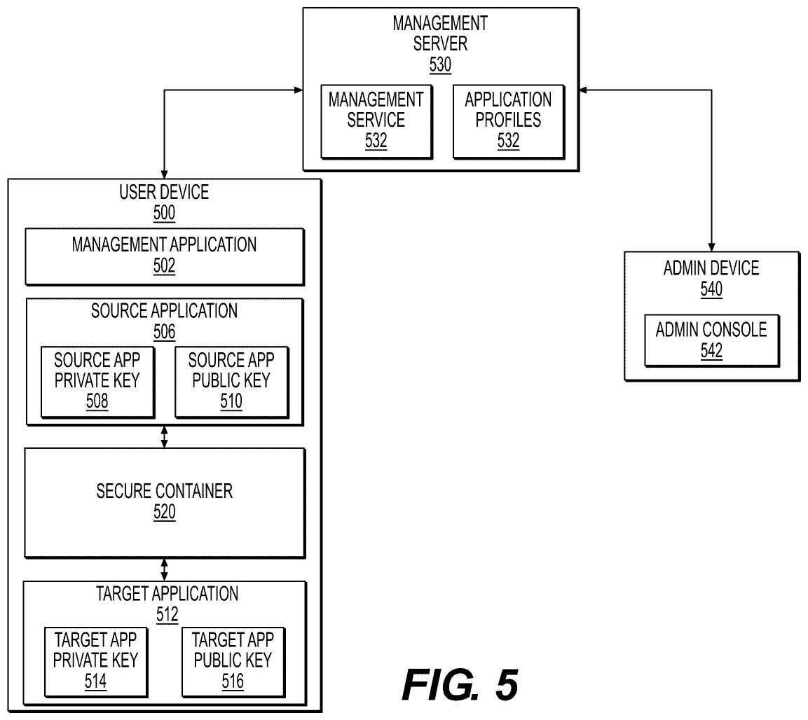

FIG. 5 is an illustration of an example system for performing secure drag and drop operations on a user device 500. The user device 500 can be one or more processor-based devices, such as a personal computer, tablet, or cell phone. The user device 500 can include a management application 502 that can communicate with a management server 530, allowing UEM management of the user device 500 based on compliance and security settings at the management server 530. The management server 530 can be a server that is responsible for managing user devices enrolled in a UEM system. The management server 530 can be a single server or a group of servers, including multiple servers implemented virtually across multiple computing platforms. In an example, the management server 530 can manage enrolled user devices, such as the user device 500, using a management service 532 that sends management instructions to the management application 502. The management application 502 can be a stand-alone application, part of an enterprise application, or part of an OS of the user device 500.

The management application 502 can be responsible for ensuring that the user device 500 is up to date with compliance and security settings prior to accessing enterprise data and resources. The management application 502 can enforce compliance at the user device 500, such as by locking the user device 500, notifying an admin, or wiping enterprise data when compliance standards are not met. Example compliance standards can include ensuring a device is not jailbroken, that particular encryption standards are used in enterprise data transmission, that the device does not have certain blacklisted applications installed or running, and that the device is located within a geofenced area when accessing certain enterprise resources. In one example, the user device 500 can access enterprise or UEM resources through the management server 502.

The user device 500 can include a source application 506 and a target application 512, which can be managed applications. A managed application can allow an enterprise to control access and functionality of the application, including data files in the application's file system. A managed application can persist locally on the user device 500 or can be accessed from within the management application 502, depending on the example. Even when a managed application is accessed remotely, portions of that application or data utilized by the application can exist locally on the user device 500.

The source application 506 can be any application that a user drags content from in a drag and drop operation, and the target application 512 can be any application that a user drags content to in a drag and drop operation. The management server 530 can store application profiles 534 for enterprise managed applications. Application profiles 534 can designate what operations are and are not allowed for an application on a user device, including permissions related to drag and drop operations. For example, an application can be allowed to only send content, receive content, or both send and receive content through drag and drop operations. An application profile 534 can also designate which applications an application can exchange content with using drag and drop operations. For example, an application can be limited to exchanging content through drag and drop operations only with other managed applications on the user device. In one example, an application profile 534 can designate specific applications that an application can perform drag and drop operations with. This can include whether the application can send, receive, or both send and receive drag and drop content with any specific application. As an example, an application profile 534 can allow the target application 512 to receive, but not send, content through drag and drop operations. In another example, an application profile can allow the source application 506 to send, but not receive, content through drag and drop operations. In another example, application profiles 534 can allow the source application 506 to send content to the target application 512 using drag and drop operations, but not the other way around.

Application profiles 534 can be managed by admin users through an admin console 542. The admin console 542 can be any interface that allows an admin to manage user accounts and configuration settings for an organization, including application profiles 534. The admin console 542 can be accessed using an admin device 540, which can be any user device, such as a computer, tablet, or phone, that displays the admin console 542.

The source application 506 and target application 512 can include their own encryption key pairs. For example, the source application 506 includes a source app private key 508 and a source app public key 510. The target application 512 includes a target app private key 514 and a target app public key 516. Managed applications can exchange keys with each other when content is dragged from one managed application to another. For example, when a user drags content from the source application 506 to the target application 512, the target application 512 can provide the source application 506 with the target app public key 516, and source application 506 can encrypt the content with the target app public key 516. The source application 506 can send the encrypted content to the target application 512, and the target application 512 can decrypt the content using the target app private key 514. The source application 506 and target application 512 can communicate with each other (e.g., exchanging public encryption keys and encrypted content) using any available communication protocol, such as APIs.

The user device 500 can include a secure container 520 for use in securely transferring content in drag and drop operations. The secure container 520 can be an application or service that allows a user to share content between trusted applications installed on the user device. For example, the secure container 520 can be software that contains all the code and dependencies, including binaries, libraries, and configuration files, needed for securely storing dragged content in a protected environment. In an example, only trusted applications can be given access to the secure container 520. In one example, the secure container 520 can communicate with trusted applications on a secure P2P channel within the user device 500. Trusted applications can be given configuration settings and credentials required for communicating on the secure P2P channel. The secure container 520 can be configured to only communicate on the secure P2P channel, so only trusted applications can communicate with the secure container 520. The secure container 520 can protect data content from unauthorized access both inside and outside the user device 500. When a user drags content from the source application 506 to the target application 512, the secure container 520 can handle the transfer.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented is only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

1. A method for securely sharing content between applications through parallel data sharing, comprising:
receiving a first input for dragging content in a first application to a first plug-in for a secure container running in the first application;
storing the content in the secure container;
generating an identifier associated with the content;
receiving a second input for dragging the identifier from the secure container to a second application;
encrypting the content using a public encryption key provided by the second application; and
based on the second input, transferring the content to the second application, wherein the content is decrypted at the second application using a private encryption key that corresponds to the public encryption key.

2. The method of claim 1, wherein, prior to storing the content in the secure container, the first application verifies with an application profile that the first application has permission to drag the content to the secure container.

3. The method of claim 1, wherein storing the content in the secure container includes encrypting the content using an encryption key stored by a Trusted Execution Environment or Secure Element.

4. The method of claim 1, wherein storing the content in the secure container includes storing the content in a secure storage system provided by an operating system that the first application runs in.

5. The method of claim 1, wherein the second input includes a drag and drop input from a second plug-in running in the second application to the second application.

6. The method of claim 5, wherein the drag and drop input includes a drag selection of an identifier associated with the content that is displayed in an interface of the second plug-in.

7. The method of claim 1, wherein, based on the second input, the second application verifies with an application profile that the second application has permission to receive the content to the secure container.

8. A non-transitory, computer-readable medium containing instructions that, when executed by a hardware-based processor, causes the processor to perform stages for securely sharing content between applications through parallel data sharing, the stages comprising:
receiving a first input for dragging content in a first application to a first plug-in for a secure container running in the first application;
storing the content in the secure container;
generating an identifier associated with the content;
receiving a second input for dragging the identifier from the secure container to a second application;
encrypting the content using a public encryption key provided by the second application; and
based on the second input, transferring the content to the second application, wherein the content is decrypted at the second application using a private encryption key that corresponds to the public encryption key.

9. The non-transitory, computer-readable medium of claim 8, wherein, prior to storing the content in the secure container, the first application verifies with an application profile that the first application has permission to drag the content to the secure container.

10. The non-transitory, computer-readable medium of claim 8, wherein storing the content in the secure container includes encrypting the content using an encryption key stored by a Trusted Execution Environment or Secure Element.

11. The non-transitory, computer-readable medium of claim 8, wherein storing the content in the secure container includes storing the content in a secure storage system provided by an operating system that the first application runs in.

12. The non-transitory, computer-readable medium of claim 8, wherein the second input includes a drag and drop input from a second plug-in running in the second application to the second application.

13. The non-transitory, computer-readable medium of claim 12, wherein the drag and drop input includes a drag selection of an identifier associated with the content that is displayed in an interface of the second plug-in.

14. The non-transitory, computer-readable medium of claim 8, wherein, based on the second input, the second application verifies with an application profile that the second application has permission to receive the content to the secure container.

15. A system for securely sharing content between applications through parallel data sharing, comprising:
a memory storage including a non-transitory, computer-readable medium comprising instructions; and
a hardware-based processor that executes the instructions to carry out stages comprising:
receiving a first input for dragging content in a first application to a first plug-in for a secure container running in the first application;
storing the content in the secure container;
generating an identifier associated with the content;
receiving a second input for dragging the identifier from the secure container to a second application;
encrypting the content using a public encryption key provided by the second application; and
based on the second input, transferring the content to the second application, wherein the content is decrypted at the second application using a private encryption key that corresponds to the public encryption key.

16. The system of claim 15, wherein, prior to storing the content in the secure container, the first application verifies with an application profile that the first application has permission to drag the content to the secure container.

17. The system of claim 15, wherein storing the content in the secure container includes encrypting the content using an encryption key stored by a Trusted Execution Environment or Secure Element.

18. The system of claim 15, wherein storing the content in the secure container includes storing the content in a secure storage system provided by an operating system that the first application runs in.

19. The system of claim 15, wherein the second input includes a drag and drop input from a second plug-in running in the second application to the second application.

20. The system of claim 19, wherein the drag and drop input includes a drag selection of an identifier associated with the content that is displayed in an interface of the second plug-in.
